(19) United States
(12) Patent Application Publication
(10) Pub. No.: US 2006/0132600 A1
(43) Pub. Date: Jun. 22, 2006

(54) Driving aid device

(76) Inventor: Jean-Loup Chretien, Morlaix (FR)

Correspondence Address: BACHMAN & LAPOINTE, P.C., 900 CHAPEL STREET, SUITE 1201, NEW HAVEN, CT, 06510, US

(21) Appl. No.: 10/554,522

(22) PCT Filed: Apr. 23, 2004
(86) PCT No.: PCT/FR04/50171

§ 371 Date: Jan. 17, 2006

(30) Foreign Application Priority Data
Apr. 25, 2003 (FR) 0350133

(51) Int. Cl. H04N 7/18; H04N 7/00; H04N 9/47

(52) U.S. Cl. 348/148; 348/113

(57) ABSTRACT

A driving aid device for a vehicle comprises a means for imaging and a means for projecting a virtual image in a field of vision of a driver, an opaque screen, arranged in the field of view of the driver, for the formation of a virtual image focused at infinity in the field of vision of the driver of the vehicle, and further comprises means for filtration of zones of high luminous intensity.

### BACKGROUND OF THE INVENTION

(1) Field of the Invention

The present invention concerns the field of driving assistance and more particularly equipment intended to improve vision in vehicles.

(2) Prior Art

Various solutions are known in the prior art, generally based on “head-up” vision systems.

Thus the patent EP0686865 describes a night vision system for a motorised vehicle comprising an infrared camera mounted on the vehicle in order to examine a scene on a roadway in front of the vehicle and to produce a video signal representing a thermal network of the scene. A head-up display device coupled to the video signal produces a virtual signal having a one-to-one size ratio with the images of the actual roadway scene seen by the vehicle driver. The head-up display device comprises a mixer in the field of view of a driver of the vehicle, a video display device for emitting a signal based on the video signal, and an aspherical mirror for reflecting the image emitted on the mixer in order to be seen by the driver as a virtual image of the thermal network of the scene. The head-up display device superimposes the virtual image of the thermal network with a shift of a few degrees with respect to the scene of the roadway so that the driver observes the virtual image of the thermal pattern under the scene of the actual roadway, so as to warn the driver of the presence of objects beyond the visible field of view of the driver.

The problem posed by such equipment is that of processing the content of high contrast, for example the appearance of a headlight in the field of view of the camera, as well as that of the aberrations resulting from the shift between the virtual image and the real image.

The American patent U.S. Pat. No. 5,903,396 describes a light intensification device for automobile driving, using optical polarisers for improving the virtual image seen by the driver.

The patent PCT WO0234572 describes another system for night vision intended for a powered vehicle. The camera captures an image that is subsequently displayed on a display system, which can be a head-up display system. The camera comprises a lens in alignment with a beam deflector that can consist of a mirror diverting the beams so that it passes along a neck in the direction of a sensor. The camera can be mounted relatively easily in position in a powered vehicle.

Systems are also known for displaying information in the field of view of the driver.

The patent PCT WO8903059 describes an optical display system that allows the individual presentation of basic information to an observer. It comprises a vision unit that comprises reflective surfaces through which an observer can look at a scene outside and which reflects basic information coming from an information source that displays them in front of the observer. In a preferred embodiment, the optical display system described consists of a display system of the head-up type for an automobile and the observer is the driver of the vehicle. The vision unit consists of an automobile windscreen with or without material improving reflection and whose internal and external surfaces reflect the basic information conveyed by the light propagating from the information source, represented for example by a liquid crystal display unit (32). A system with a projection lens placed between the internal surface of the windscreen and the information source has optical properties of light conduction that compensates for any optical aberrations caused by the non-planar surface of the windscreen. The projection-lens system comprises a single aspherical element with a specific aspherical windscreen shape and elements remain in common to a large number of different windscreen shapes. A positioning mechanism enables the driver to adjust the vertical position of the basic information reflected by the windscreen in a total-display vision field offering an optimum view to a seated driver. The positioning mechanism also makes it possible to automatically vary the distance separating the displayed image and the driver according to the speed of the vehicle, which increases the safety of use of the vehicle.

Other documents concern mixed solutions relating to information display and a virtual image acquired by camera.

The patent WO03016983 concerns a vehicle provided with a camera generating infrared images of a scene situated in front of the vehicle, and a display that reflects images from the windscreen of the vehicle. The following are displayed: at night, images transmitted by the camera and, by day, information on the vehicle. The display device comprises a mirror provided with reflective surfaces for day and night that have different optical characteristics and that are disposed aslant. The mirror pivots and makes the display unit pass from one display mode to the other. In another display system, the radiation from the dual-faced mirror reaches the driver directly, without reflection by the windscreen.

These various solutions are not totally satisfactory since they do not provide a virtual image visible to infinity under all visibility conditions: day, night, dazzling areas by a source highly contrasted with respect to ambient lighting.

### SUMMARY OF THE INVENTION

The aim of the present invention is to remedy these drawbacks by proposing a vision system for driving a vehicle providing the formation of a virtual image at infinity, in the field of view of the driver.

To this end, the invention concerns, according to its most general meanings, a device assisting the driving of a vehicle comprising a means for photographing and a means for projecting a virtual image in the field of view of the driver, characterised in that it comprises an optical screen placed in the field of view of the driver for forming a virtual image projected to infinity in the field of view of the driver of the vehicle and in that it also comprises means for filtering areas of high light intensity.

According to a first variant, the optical axis of the said photographing means corresponds substantially to the principal axis of the field of view of the driver.

According to a second variant, the optical axis of the said photographing means corresponds substantially to the principal axis of the rear-view field of the driver.

According to a third variant, the optical axis of the said photographing means corresponds to lateral field of the driver.

According to a particular embodiment, the photographic means comprises a camera and/or an optical transmission unit.

The said photographic means preferably comprises a first means for photographing in daytime conditions and a second means for photographing in night-time conditions and means for selecting one of the said photographic means.

Advantageously, the said means for filtration of the areas of high light intensity comprises an incident image analyser controlling a means of inhibiting areas whose brightness exceeds a threshold value.

According to a preferred variant, the said inhibition means consists of a coronagraph.

According to another variant, the said inhibition means consists of a matrix of variable-transmission elements controlled by the image analyser.

Advantageously, the night-time photographing means comprises a red filter.

Advantageously, the field of the photographic means is greater than or equal to 40 degrees.

According to a variant, the daytime photographic means comprises a first polariser of the LCD matrix.

According to the preferred embodiment, the daytime photographic means comprises a first optical unit comprising a UV filter, a coloured filter and a safety diaphragm, a beam divider reflecting a portion of the beam to a CCD detection surface for analysing the incident image and a second optical unit comprising a coronagraph, the LCD matrix, the second polariser and the field lens.

According to a particular embodiment, the daytime photographic means comprises a semi-transparent mirror reflecting part of the incident beam to an image analyser and allowing the other part of the incident beam to pass by transmission.

According to another advantageous embodiment, the device comprises a movable unit comprising the daytime photographic means and a monitor for displaying an image obtained by the night-time photographic camera, the said movable unit being able to moved between a first position in which the entry of the daytime photographic means is situated in the photographing axis and the exit from the said daytime photographic means is placed in the optical axis of the virtual image formation system, and a second position in which the entry of the night-time photographic means is situated in the photographing axis and the monitor is placed in the optical axis of the virtual image formation system.

The night-time photographic means preferably comprises a means of occulting an area of high light intensity at least, placed in front of the camera lens.

Advantageously, the said means of occulting an area of high light intensity consists of a perforated mirror whose position is controlled by an incident image analyser, the said mirror being placed on the optical path in order to return to the camera the incident image apart from the area of high light intensity.

According to a variant, the perforated mirror is replaced by a glass blade on which there is situated a cone for blocking/reflecting the image of the sun. This cone has the size of the image of the sun plus 10% to 20%. The function is that of a coronagraph, that is to say the reverse of a mirror system with a hole.

According to a particular variant, the device comprises means of calculating the theoretical position of the sun with respect to the photographing axis and for controlling the position of the coronagraph.

According to another variant embodiment, it comprises a processor for the transmission of an LCD matrix of the negative images of the other sources that exceed an adjustable maximum value.

According to yet another variant, it comprises a processor for controlling the safety diaphragm placed in front of the daytime photographing means.

According to a particular embodiment, the device comprises a gyroscopic platform intended for the stability of the coronagraph and means of correcting any delays in the detection/feedback loop during rapid movements.

Advantageously, it comprises a spherical mirror which ensures the “positioning” of the image and its transfer to the opaque screen reflecting the final image; the screen consists of a rectangular portion of a circular spherical mirror, its dimensions having to cover from the top of the windscreen to the bottom part of a normal sun visor, and laterally cover the left-hand pillar as far as the centre of the windscreen.

According to another example embodiment, the device according to the invention also comprises means of displaying specific data such as the driving parameters (speed, fuel consumption, etc), navigation parameters (GPS or others), interactive information with the external environment (coming from emissive terminals or various sensors situated in the vehicle), imagery constructed from two specific cameras, one seeing the theatre under normal conditions, including night vision, the other functioning in the IR band and capable of seeing in a degraded visibility situation.

According to a variant, the said data display means consists of a control circuit for an LCD matrix interposed between the photographing image and the opaque screen.

According to another variant, the device according to the invention comprises an entry window with a surface area less than the surface of the windscreen, comprising pollution combating, rapid defrosting, anti-rain and cleaning means.

According to yet another variant, part of the photographing lens is able to move about a principal axis.

The aim of the invention is to propose a device that is not vulnerable to excess power from sources that it might encounter in the frequency bands where it is effective. To do this, in particular for ultra-sensitive systems (night vision, IR detection, military optics), it must be able to be protected selectively in order to eliminate the nuisance from the excessive source without altering the other radiation.

In the case of road safety, the vision of the driver is by far the essential driving instrument. The eye is the main detector from which the entire algorithm for navigation of the vehicle on the road is constructed. In a more and more aggressive environmental context, essentially due to road usage always close to saturation, the margin for error is considerably reduced, whilst the performance of the driver, in particular his vision, has remained a constant. The protection of this essential instrument is therefore obvious. The Eclipse technology makes it possible to participate in this protection, as well as the protection of the optical systems which are being produced to come to the assistance of the vision of the driver. In the particular case of night vision, as will be seen later, the Eclipse system is not only a protection means but also a means of increasing night vision.

The system is interactive and totally or partially neutralises, selectively, dazzling light sources. The sources that are not selected (non-dazzling) are not affected by this filtration. In some applications, in the case of insufficient light, weak sources may on the contrary be amplified.

The basic application is intended to protect any optical system against dazzling, ranging from the eye to cameras and other optical sensors.

In addition to this filtration and amplification function, the system makes it possible to add information of all kinds, in the form of both images and text.

Finally, the optical input of the system may be favoured, so as to be the last input interface to be polluted in the case of damage to the direct input interface (the windscreen).

A bandwidth selection function makes it possible to filter or amplify a given category of sources.

This system is differentiated from existing systems by its selective interactivity, its ability to superimpose the transformed image exactly where the source is (generally at infinity) and to give to this image all of the improvements demanded for a given use.

The invention affects the key fields that are road safety, the safety of aeronautical and maritime transport, and the protection of individuals against terrorism and vandalism, and, in general terms, that participate in the comfort of persons who are subjected to aggressive light (sun, car headlights, lasers, search lights etc).

In addition to this basic function (filtration), the invention allows the following supplementary functions, in the case of a use in terrestrial transportation: superimposition of various items of information of the HUD type, amplification of excessively weak light, maintenance of an optimum level of quality of landscape observed in the case of damage to the normal input interface between the user and this landscape (windscreen for example).

The invention is particularly useful for terrestrial transport (car, coach, bus, motorcycle etc), during the night-time period. The device then proceeds with a selective dynamic filtration of the dazzle from the car headlights or any other light situated in the opposite direction to the vehicle. At the same time as the attenuation of strong sources, it offers the possibility of amplifying the sources of low light so as to considerably increase night vision. The problem encountered by a night-time driver is similar to the problem encountered in space, where the light source (the sun) is an intense light source standing out from a black sky. In night-time driving, the theatre is an identical black surface where the headlights of opposing cars (and possibly other sources), and the thin zone illuminated by the car headlights, stand out. It is easy to imagine the conditions obtained in the Eclipse window: an illuminated theatre seen by the camera amplifying the low light, the strip of road illuminated by the headlights under the Eclipse window. The camera is itself protected by the means of occulting the intense sources which prevent its own blinding, the adverse lights are seen as light spots of low intensity. In addition to this advantage with regards to safety, driving comfort is greatly improved by the fact that the light window placed in front of the driver makes it possible to choose the average light intensity corresponding to the moment when the pupil of the eye is struggling to remain open because of the low light from the theatre, whilst it would close in order to reduce the aggressiveness of adverse sources. The tendency will therefore be to be situated at a start of closure of the pupil whilst keeping an excellent view of the essential area.

The combination of two or more degraded situations is in general an exponential approach of probability of an accident. The combination of dirty windscreen and dazzle is not a rare combination. Reducing one or the other is a means of flattening out this probability. Reducing both is much more effective means for decreasing this factor by a few percent. The surface of a windscreen is too large to introduce sophisticated protection means therein other than conventional means. The input window of the Eclipse system is sufficiently small to introduce therein sophisticated pollution-combating, rapid defrost, anti-rain, cleaning, etc means.

### BRIEF DESCRIPTION OF THE DRAWINGS

The present invention will be better understood from a reading of the following description, referring to the accompanying drawings, where:

FIG. 1 depicts a schematic view of the device according to the invention, in the “night-time conditions” position;

FIG. 2 depicts a schematic view of the device according to the invention, in the “daytime conditions” position;

FIG. 3 depicts a detailed view of the elements of the device used in “daytime conditions”;

FIG. 4 depicts a detailed view of the elements of the device used in “night-time conditions”;

FIG. 5 depicts an overall view of the elements of the device used in “daytime conditions”;

FIG. 6 depicts a view of the installation of the device seen from the side;

FIG. 7 depicts a view of the installation of the device seen from above.

### DETAILED DESCRIPTION OF THE PREFERRED EMBODIMENT(S)

The invention is depicted hereinafter in the form of non-limiting examples.

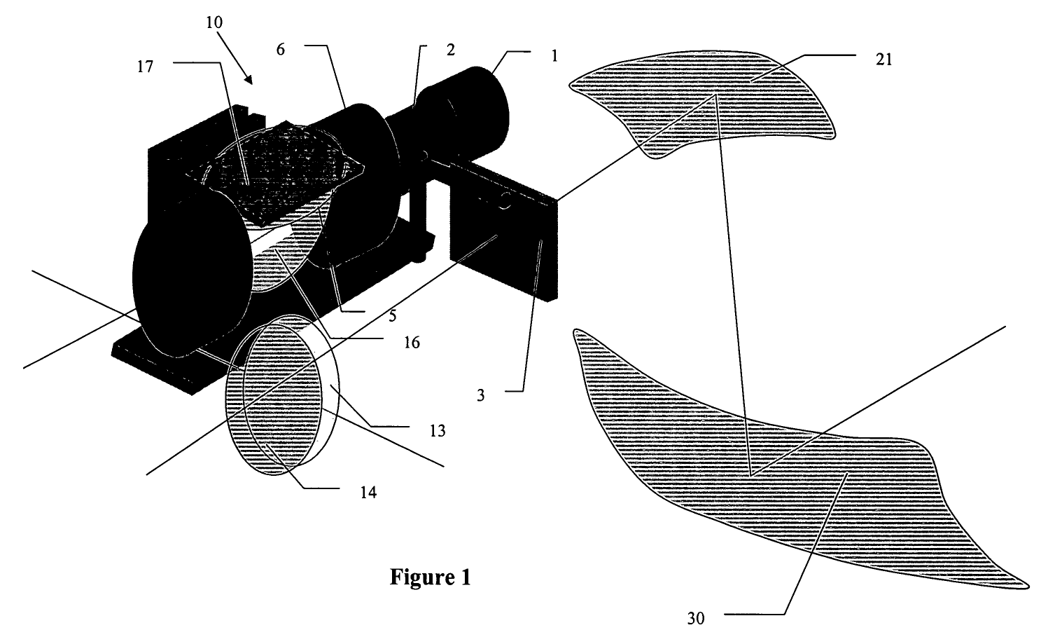

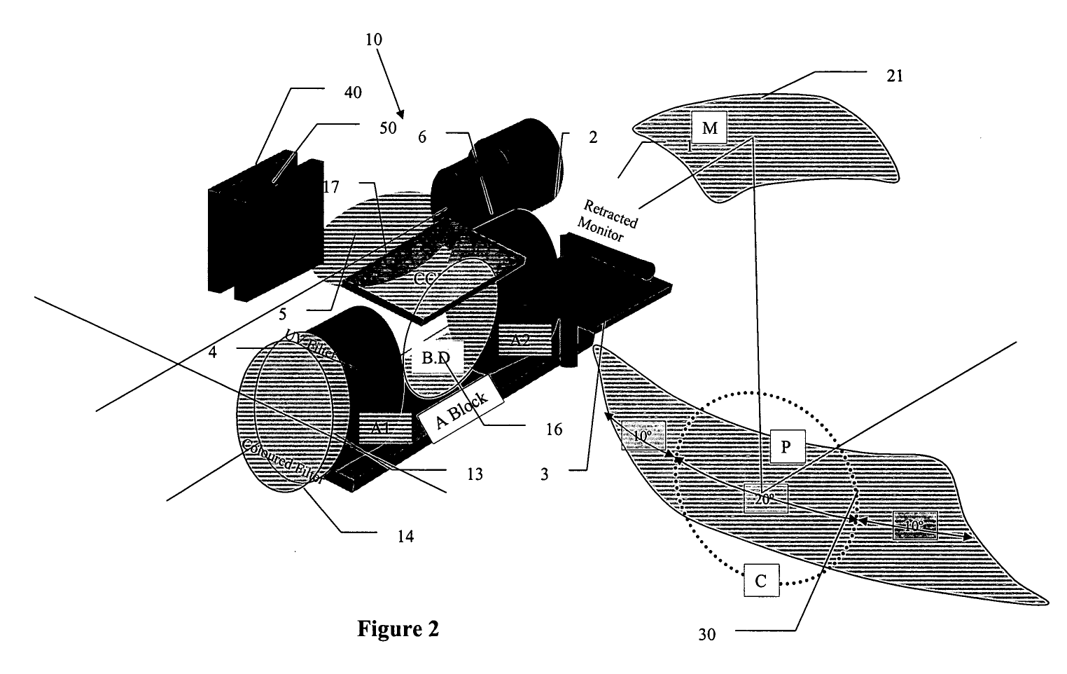

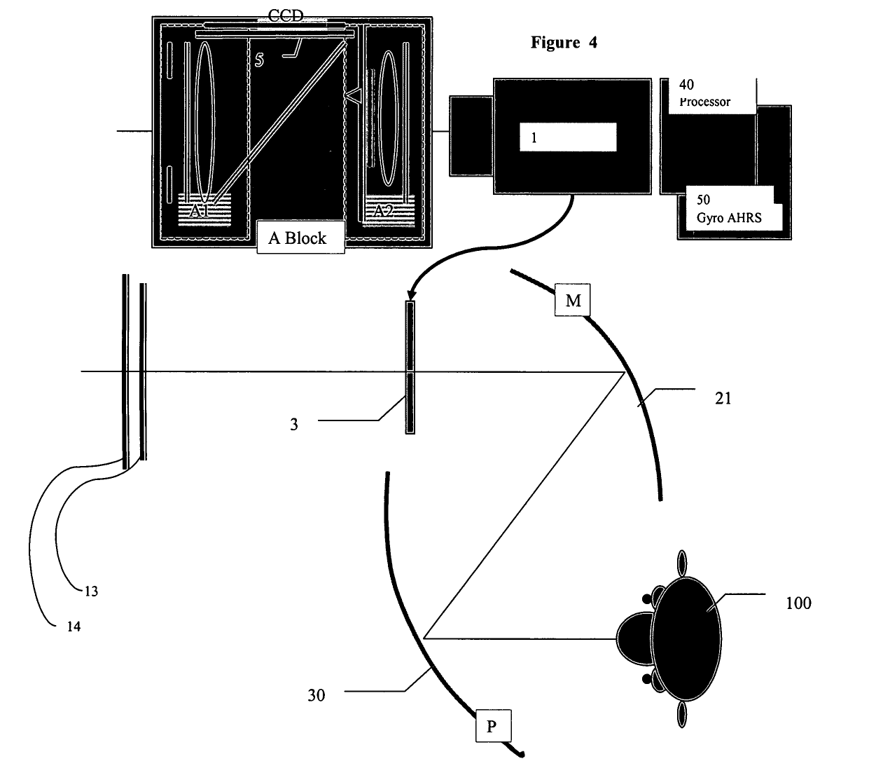

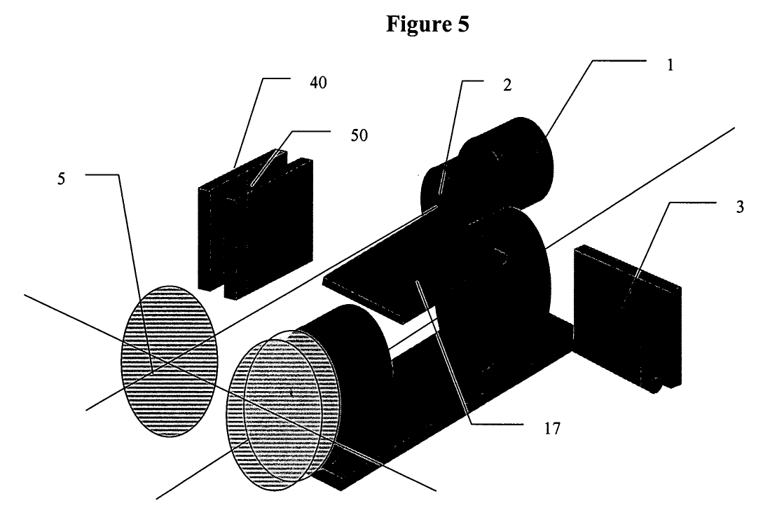

The device is composed of a movable unit (10) fulfilling the image analysis and filtration functions. This unit (10) can occupy two positions: night-time (FIGS. 1 and 4) and daytime (FIGS. 2, 3 and 5).

In the two cases of use, the final image is seen at infinity in the optical system 20/30.

The night-time vision function comprises a camera (1) receiving an image filtered by an optical module for filtration of the incident beam (6) contained in the unit (10), a red filter (5) and a monitor (3) comprising a screen on which the processed image forms.

The “daytime vision” function comprises an input lens (4) and a filtration system (6) provided with a feedback-controlled coronagraph (7). The optical input unit has an angular field of approximately 400. Apart from the lenses (11), it contains a first polariser (12) for the LCD matrix providing the first polarisation and the distribution of the heat.

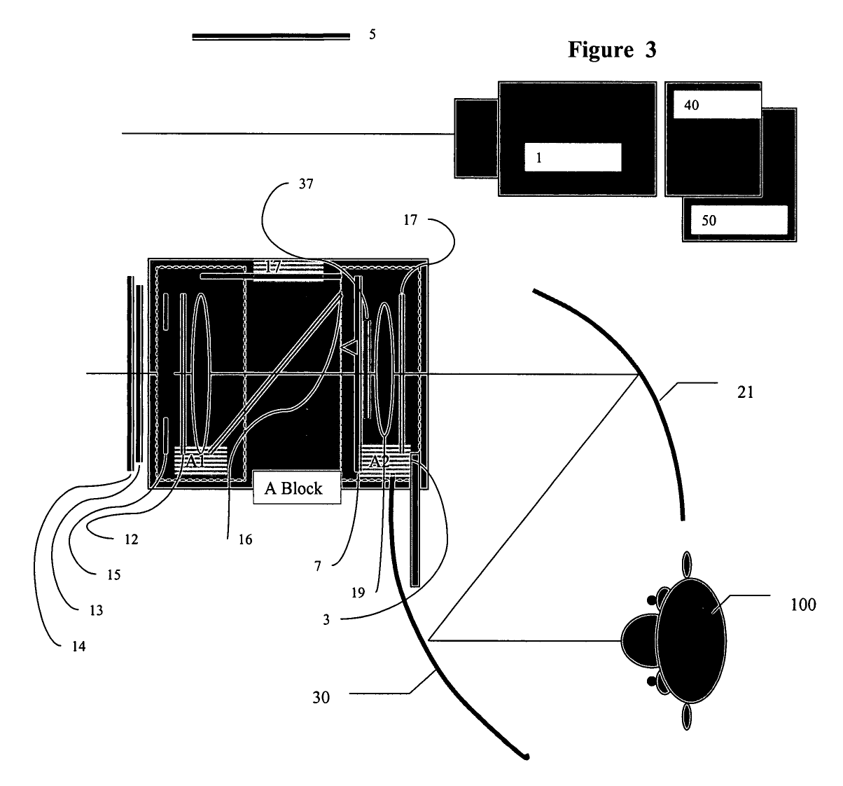

The unit A depicted for example in FIG. 3 constitutes the entire filtration system. It moves laterally from the day position to the night position according to the conditions of use. In the day position, the filtered light emerges from the optical unit A2 and is then received by the eye of the user via the two mirrors M and P (21 and 30). The monitor of the night function is of course retracted. In the night position, the unit A and everything it contains moves in front of the camera. The functioning is the same, but this time it is the camera that is protected. During this movement of the unit A, the monitor is deployed and comes to occupy a position such that, in the optical system 21/30, the image on the monitor is seen at infinity.

In the 3D views, the unit A is shown diagrammatically by a light grey horizontal support plate. The units A1 and A2 are two dark grey cylinders, A2 (6) and A1 (4).

The red filter is just below the CCD 17 in the night position. It is fixed and does not move when the unit A moves. This position is shown in FIGS. 3 and 4 but does not mechanically represent reality as in FIGS. 1 and 2, for reasons of convenience of the diagram. (Instead of being perpendicular to the plane of the figure, the CCD and red filter are in reality parallel and above this plane.)

An image analysis module (10) provides the detection of the areas of high light intensity. It comprises a circuit for processing the incident image delivering a control signal for the filtration module contained in A (LCD and coronagraph).

The device comprises two optical filters placed at the entry to the system.

The red filter (5) is intended for the camera alone and remains fixed in the system. It is situated in a plane parallel to the plane of the LCD so as to be situated just below the LCD at the end of the movement of the unit A (10) towards the night position (FIG. 1). Its role is to prevent this system from filtering the red lights of cars (or others) in the field of view, the second group (14) is intended for direct daytime observation and is placed in front of the first optical unit A1 (10) in the “daytime” position. It is also fixed and will not follow the movements of the analysis module (10). It comprises a UV filter (13), a coloured filter (14) and a safety diaphragm (15).

The analysis module (10) comprises a beam divider (16) that reflects a portion of the beam towards a CCD detection surface (17).

The optical unit (6) contains the coronagraph (7), the LCD matrix (18), the second polariser and the field lens (19).

The camera (1) is in operation when the unit (10) is in the “night-time” position. It is then protected by the anti-dazzle system (6) placed in front of the camera lens. The image transmitted from the camera to the LCD monitor (3) is seen at infinity on an opaque screen (30).

The display module (20) comprises a hemispherical mirror (21) providing the bending of the optical beams, the restitution of image and the reduction in size in order to enable the device to be housed in the cabin of a vehicle, as well as a second hemispherical mirror (30) placed in the field of view of the driver (100). The spherical mirror (21) ensures the “positioning” of the image and its transfer to the opaque screen (30). It is a rectangular portion of a homothetic circular mirror of the mirror (30).

The spherical mirror (30) constitutes the “intelligent sun visor”. It is also formed by a rectangular portion of a circular mirror, its dimensions having to cover from the top of the windscreen to the bottom part of a normal sun visor, and laterally cover the left hand pillar as far as the centre of the windscreen (more or less) . The reduced field of 22° exceeds the vertical limits of the windscreen and therefore goes outside the vertical limits of the mirror (30). In night use, the image supplied to the mirror (30) is intentionally larger than the field of the mirror (21).

The LCD monitor (3) has a “useful” surface enabling it to deliver an image which at magnification 1 will have a size greater than or equal to the field of P (40°+).

The device comprises a processor (40) receiving the information from the input CCD sensor (17). It delivers control signals to the filtration means (37) comprising an LCD matrix and (7) (the coronagraph). It also provides where necessary the lateral feedback-control of the reduced field. The aim is to obtain a field C that moves over P following the lateral position of the sun. A means would consist of connecting the unit A2 to the motor X of the coronagraph and leave the motor Y driving only the coronagraph alone.

The detection of the other sources is implemented by a CCD matrix (17) placed behind the entry lens after separation. This detection means will have to become the single detection means in the possible absence of a coronagraph in the majority of land vehicle applications. This function will be kept in aeronautical and space applications.

The processor can also use a database. This database contains in particular information on the relative position of the sun. Beyond a given power the processor (40) decides that the emissive source is the sun. A GPS navigator communicates the local coordinates to this base so as to correct the local sunrise and sunset times introduced into the database. Changing from “day” to “night” position can also be automated and make it possible to prevent, in the presence of a strong light source, the processor interpreting it as a “sun”. This information will also make it possible to adapt the maximum theoretical value of the solar source to local time and prevent the same problem in the day.

The position of the coronagraph after detection of the sun is controlled by the processor (40).

The processor (40) also carries out the processing of the information relating to the other light sources: the processor (40) transmits to the LCD matrix the negative images of the other sources that exceed a maximum adjustable value. The following are also adjustable: the density of the shield (more or less black negative image) and its contour (diffuse or sharp).

The processor (40) also controls the safety diaphragm (15): beyond a predetermined and possibly timed maximum value, the processor controls the progressive closure of the diaphragm (15). This safety device should intervene only in rare cases where the sun is high over the horizon. For the user this would be represented, apart from an eclipse of the sun, by a darkening of the landscape, which can have an advantage in a period of strong sunshine.

The gyroscopic platform (50) is associated with the processor (40) and continuously supplies information dX, dY which makes it possible to correct any delays in the detection/feedback loop during rapid movements. It also makes it possible to maintain the position of the coronagraph (7) during momentary disappearance of the sun.

The coronagraph (7) produces the occultation of the sun. It is implemented by a reflective conical piece. The light that forms the image of the sun is therefore returned to the walls of the instrument. Thus its return to the lens is prevented, since the latter would reflect a path which would interfere with the weak image of the corona. It is at the base of this cone that the image of the sun is formed.

The functioning of the device is as follows:

By day, the beam passes through the filtration system (6, 10). The beam is processed at the unit A2 (FIG. 3) where the field lens limits the output angle to 22°. The beam is reflected by the first spherical mirror M capable of an angle of 40°+. The image is seen on the spherical mirror (30) in a circle C corresponding to the limit field of 20°. The mirror (21) is also capable of an angle of 40°+.

At night: the analysis module (10), containing the entry lens A1 and the intermediate filtering lens plus field lens, moves towards the camera so as to become the camera filter. The mirrors (21) and (30) remain fixed. An LCD monitor (3) comes to take the place of the unit (6). The camera sees a field of 40°, which it supplies to this monitor (3). The size of the monitor should be such that its image seen in (30) is never smaller than the field offered by (30).

The input image is supplied by a camera (1) associated with anti-dazzle equipment and transmitted on an LCD colour monitor (3) or possibly to the LCD matrix normally used for filtration. The field of the camera is adjusted so that we have as an output a magnification of 1. The image is seen at infinity in the output lens. This system offers the possibility of getting around the difficulty of the entry angle. It has suitability for processing, in a way that is both filtering and amplifying, highly contrasted situations where the strong sources are too strong and the rest of the sources too weak. This is the case at night, and the problem of night vision appears to be one of the essential preoccupations at this time.

The implementation of the device can comprise several variants:
basic system: changing lens for maximum entry angle. Strong source filtration by SHM/coronagraph. Filtration of other sources by LCD matrix (or other active matrix such as DMD for example). Detection PSD to SHM and detection camera to LCD. Suitability HUD info demonstrable via laptop.

Particularities: positioning of first polariser: equipped with entry UV filter, and possibly a red filter to prevent filtration of red lights at night.
Modified basic system: only one filtration stage per LCD matrix (or other), after verification of the limits of the matrix, and occasional addition of a coloured filter in addition to the UV filter. Detection by video camera.
Developed basic system: capable of a field angle of at least 40° by means of combinations of cylindrical lenses and spherical mirrors. Detection by branching a portion of the entry beam to a CCD matrix as described above.
Basic hybrid system: can be designed after fabrication of a camera equipped with an anti-dazzle system (protection by LCD matrix+filters). Detection by video camera as in previous system.
Developed hybrid system: capable of the HUD function, seen on an LCD matrix placed in another image plane and occupying only part of the field, seen at an adjustable distance less than infinity.
Future system: enables the user to choose between the basic function and the hybrid function. Composed of:
the entry lens and branching towards the CCD matrix,
a sensitive camera having good performance in low illumination and equipped with anti-dazzle protection, upstream supplementary protection by UV filter permanently installed, red filter and coloured filter automatically removable according to the luminance detected by the sensor, and possibly an automatic diaphragm after detection of risk of overheating,
an LCD matrix fulfilling two functions: filter function in the basic case, monitor function in the hybrid case. In the latter case, the image supplied by the sensitive camera is delivered to the LCD matrix. This matrix normally being used in video projectors, it will be easy to make from it a luminous monitor by means of a frosted glass and an adjustable-power lamp placed automatically downstream of the matrix in the case of hybrid use.
A system with data display.

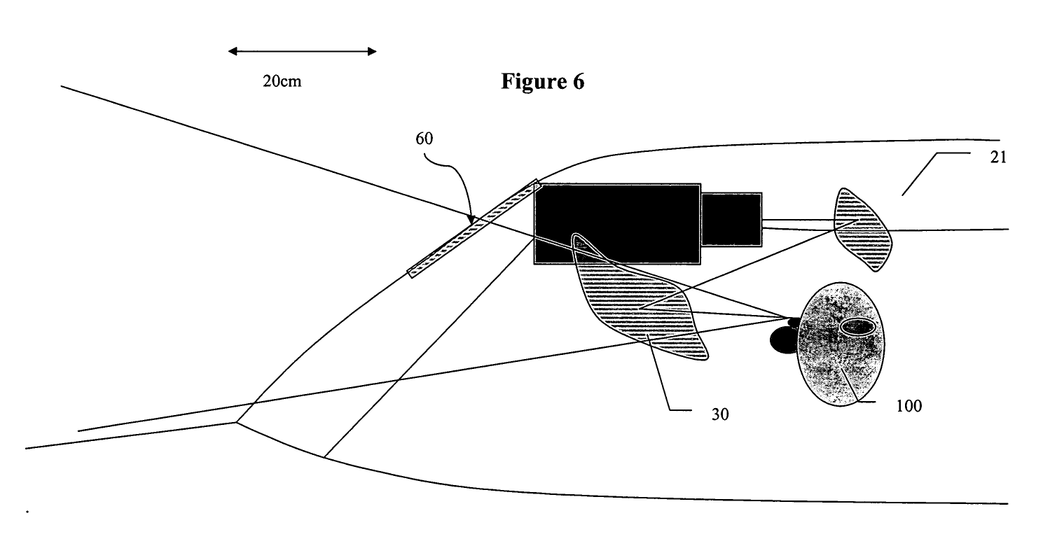

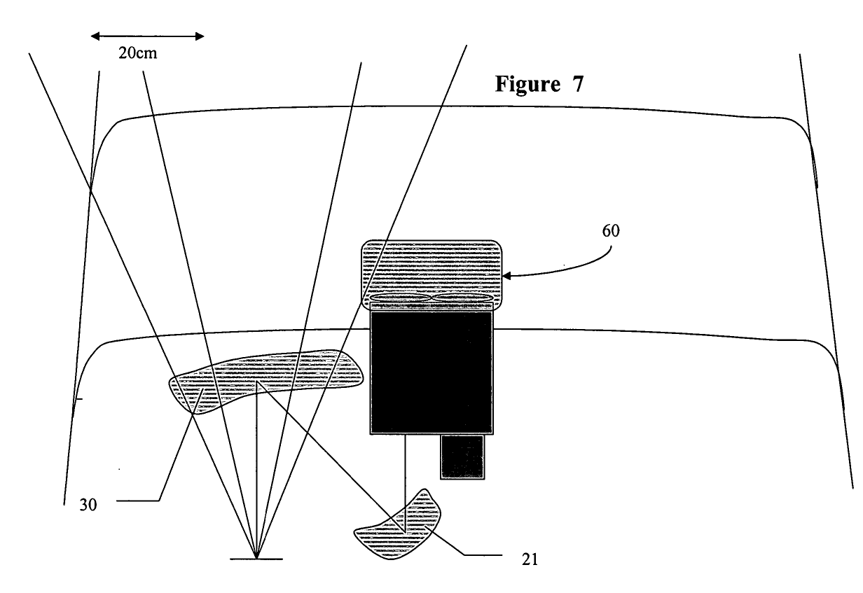

On the intelligent sun visor specific data can be displayed on request: driving parameters (speed, fuel consumption, etc), navigation parameters (GPS or others), interactive information with the external environment (coming from emissive terminals or various sensors situated in the vehicle, and imagery constructed from two specific cameras, one seeing the theatre under normal conditions, including night vision, the other functioning in the IR band and capable of seeing a situation of degraded visibility.
System with “clean surface” input. FIGS. 6 and 7 depict schematic views of installation in the cabin of a vehicle.

1-30. (canceled)

31. A device assisting the driving of a vehicle, comprising a means for photographing and a means for projecting a virtual image in a field of view of a driver, an opaque screen consisting of a mirror placed in the field of view of the driver for forming a virtual image projected to infinity in the field of view of the driver of the vehicle, and means for filtering areas of high light intensity.

32. A device for assisting the driving of a vehicle according to claim 31, wherein an optical axis of said photographing means corresponds substantially to a principal axis of the field of view of the driver.

33. A device for assisting the driving of a vehicle according to claim 31, wherein an optical axis of said photographing means corresponds substantially to a principal axis of a rear view field of the driver.

34. A device for assisting the driving of a vehicle according to claim 31, wherein an optical axis of said photographing means corresponds to a lateral field of view of the driver.

35. A device for assisting the driving of a vehicle according to claim 31, wherein said photographing means comprises a camera.

36. A device for assisting the driving of a vehicle according to claim 31, wherein said photographing means consists of an optical transmission unit.

37. A device for assisting the driving of a vehicle according to claim 31, wherein said photographing means comprises a first means for photographing in daytime conditions and a second means for photographing in night-time conditions.

38. A device for assisting the driving of a vehicle according to claim 37, further comprising means for selecting one of said first and second photographing means.

39. A device for assisting the driving of a vehicle according to claim 31, wherein said means for filtering the areas of high light intensity comprises an incident image analyser controlling a means of inhibiting areas whose brightness exceeds a threshold value.

40. A device for assisting the driving of a vehicle according to claim 39, wherein said inhibition means consists of a coronagraph.

41. A device for assisting the driving of a vehicle according to claim 39, wherein said inhibition means consists of a variable transmission matrix of elements controlled by the image analyser.

42. A device for assisting the driving of a vehicle according to claim 37, wherein said night-time photographing means comprises a red filter.

43. A device for assisting the driving of a vehicle according to claim 31, wherein the photographing means has a field which is at least 40°.

44. A device for assisting the driving of a vehicle according to claim 37, wherein the daytime photographing means comprises a first polariser for an LCD matrix.

45. A device for assisting the driving of a vehicle according to claim 44, wherein daytime photographing means comprises a first optical unit comprising a UV filter, a colored filter and a safety diaphragm, a beam divider reflecting a portion of a beam towards a CCD detection surface for analysing an incident image and second optical unit comprising a coronagraph, the LCD matrix, a second polariser and a field lens.

46. A device for assisting the driving of a vehicle according to claim 37, wherein daytime photographing means comprises a semi-transparent mirror reflecting part of an incident beam towards an image analyser and allowing another part of the incident beam to pass by transmission.

47. A device for assisting the driving of a vehicle according to claim 37, wherein the device comprises a moving unit comprising the daytime photographing means and a monitor for displaying an image obtained by the night-time photographing camera, the moving unit being able to be moved between a first position in which an input of the daytime photographing means is situated in a photographing axis and an output of the daytime photographing means is placed in an optical axis of a virtual image formation system, and a second position in which an input of the night-time photographing means is situated in the photographing axis and the monitor is placed in the optical axis of the virtual image formation system.

48. A device for assisting the driving of a vehicle according to claim 37, wherein the night-time photographing means comprises a means for occulting an area of high light intensity at least, placed in front of a camera lens.

49. A device for assisting the driving of a vehicle according to claim 48, wherein the means for occulting an area of high light intensity consists of a perforated mirror whose position is controlled by an incident image analyser, said mirror being placed on an optical path in order to return to a camera an incident image apart from the area of high light intensity.

50. A device for assisting the driving of a vehicle according to claim 31, further comprising means for calculating a theoretical position of the sun with respect to a photographing axis and for controlling a position of a coronagraph.

51. A device for assisting the driving of a vehicle according to claim 31, further comprising a processor for transmitting to an LCD matrix negative images of another source that exceed an adjustable maximum value.

52. A device for assisting the driving of a vehicle according to claim 37, further comprising a processor for controlling a safety diaphragm placed in front of the daytime photographing means.

53. A device for assisting the driving of a vehicle according to claim 31, further comprising a gyroscopic platform intended to stabilise a position of a coronagraph and means for correcting any delays in a detection/feedback loop during rapid movements.

54. A device for assisting the driving of a vehicle according to claim 31, further comprising a spherical mirror that ensures positioning of the image and its transfer to the opaque screen.

55. A device for assisting the driving of a vehicle according to claim 31, wherein a spherical screen consists of a rectangular portion of a circular spherical mirror, said spherical screen having dimensions to cover from a top of a windscreen to a bottom part of a sun visor and laterally cover a left-hand pillar as far as a center of the windscreen.

56. A device for assisting the driving of a vehicle according to claim 55, wherein the spherical screen consists of an assembly comprising flat lenses of a Fresnel type and one of planar and spherical mirrors.

57. A device for assisting the driving of a vehicle according to claim 31, further comprising means for displaying specific data selected from the group consisting of driving parameters, navigation parameters, interactive information with an external environment, and imagery constructed from two specific cameras, with one camera seeing a theater in normal conditions, including night vision, and the other camera functioning in an IR band and seeing in a degraded visibility situation.

58. A device for assisting the driving of a vehicle according to claim 57, wherein said data display means consists of a control circuit for an LCD matrix interposed between a photographed image and the opaque screen.

59. A device for assisting the driving of a vehicle according to claim 31, further comprising an entry window with a surface area less than a surface area of a windscreen, comprising a pollution-combating, rapid defrosting, anti-rain and cleaning means.

60. A device for assisting the driving of a vehicle according to claim 31, wherein a part of a photographic lens is able to move about a principal axis.
